(19) United States
(12) Patent Application Publication
(10) Pub. No.: US 2025/0293015 A1
(43) Pub. Date: Sep. 18, 2025

(54) System and Methods for Time of Flight Using an Ion Detector

(71) Applicant: CMP Scientific Corp., Brooklyn, NY (US)

(72) Inventors: Joshua Wiley, Auburn, CA (US); David E. Lake, JR., Grass Valley, CA (US); Christopher D. Nagy, Auburn, CA (US); Qiangwei Xia, Brooklyn, NY (US)

(73) Assignee: CMP Scientific Corp., Brooklyn, NY (US)

(21) Appl. No.: 18/603,008

(22) Filed: Mar. 12, 2024

(51) Int. Cl. H01J 49/40

(52) U.S. Cl. CPC H01J 49/40

(57) ABSTRACT

Systems and methods for calculating time-of-flight (TOF) are provided. In some embodiments, a TOF system may launch the one or more charged particles from the first location to the detector at the second location along a path using the pusher assembly. The system may determine a TOF for each of the one or more charged particles. The TOF system may include a high-voltage pulse generator, a pulse detector, a TDC, a detection comparator, a start latch, a stop latch, and a control system. The high-voltage pulse generator may output a high voltage pulse to cause the pusher assembly to launch the one or more charged particles. The pulse detector may detect the high voltage pulse and output a start signal. The TDC may determine the TOF for each of the one or more charged particles based on a stopwatch.

### FIELD OF THE DISCLOSURE

This disclosure relates to systems and methods for analyzing samples. More particularly, this disclosure relates to improved mass spectrometry devices, components therefore, and methods of use thereof.

### BACKGROUND

Mass spectrometry is an analytical technique that can be used to analyze samples. Among other applications, mass spectrometry can be used to analyze the composition of a sample. Mass spectrometers may operate by applying energy to a sample, causing the sample to emit ions. The ions may travel through an electric field and their collision with a detector may be measured. The position at which the particles are detected or the time required for the ion to reach the detector may vary with the mass of the ion. Accordingly, by measuring these parameters, a mass of the ions may be determined, and a composition of the sample may be inferred.

Time-of-flight mass spectrometers operate by measuring the time required for an ion to travel to a detector. Time-of-flight mass spectrometers may include a particle guide that directs ions toward a detector. Certain particle guides, called quadrupoles, may include segments having four electrodes that are collectively disposed around a central channel through which ions may travel. Mass spectrometers generally have multiple chambers at different pressures, which has traditionally created a need for multiple particle guides. Particle guides are complex electrical devices, and requiring multiple particle guides can significantly increase cost and manufacturing difficulty. There may also be a risk that the multiple quadrupoles will not be correctly aligned or synchronized, which can reduce performance.

Additionally, as ions are directed to enter a particle guide, droplets and other particles may become deposited around the entrance to the particle guide, which can create contamination risk and negatively impact the accuracy of future measurements.

Additionally, the time for an ion to travel to a detector may depend on the mass and charge of an ion. A mass spectrometer may calculate a mass (or charge, or path) of an ion based on the measured time it takes for the ion to reach the detector. Such a calculation may require accurate readings of start and stop times, as an error or uncertainty to start or stop times may result in an erroneous ion mass (or charge or path). Time delays between initiation and reaction (e.g., electronic jitter), which are inherent in any electronic processing path, may cause errors or uncertainties to the start and stop times. Accordingly, there is a need for systems and methods that minimize and/or mitigate these time delays.

Accordingly, there is a need for systems and methods that accurately analyze sample composition with improved reliability and lower cost. Further, there is a need for mass spectrometers having improved skimmer arrangements that reduce the risk of contamination and improve measurement accuracy.

### SUMMARY

The following description presents a simplified summary in order to provide a basic understanding of some aspects described herein. This summary is not an extensive overview of the claimed subject matter. It is intended to neither identify key or critical elements of the claimed subject matter nor delineate the scope thereof.

In some embodiments, a mass spectrometer may be provided. In some embodiments, the mass spectrometer may include a source configured to output one or more ions, a plurality of chambers having different pressures, a detector configured to detect the one or more ions, and a particle guide. The plurality of chambers may include at least a first chamber having a first pressure that is less than atmospheric pressure and a second chamber having a second pressure that is less than the first pressure. In some embodiments, the particle guide may include a conduit through which the one or more ions may travel an entire length of the particle guide. The conduit may be disposed within at least the first chamber and the second chamber. The particle guide may further include a housing surrounding the conduit. In some embodiments, the housing may include a first open section comprising a first vent, the first vent defining a passage between the first chamber and the conduit, a second open section comprising a second vent, the second vent defining a passage between the second chamber and the conduit, and a closed section disposed between the first open section and the second open section, at least part of the closed section being disposed at a juncture between the first chamber and the second chamber. The one or more ions may be configured to travel from the source, through at least the first chamber, the second chamber, and the particle guide, and to the detector.

In some embodiments, the conduit may include a quadrupole. In some embodiments, the quadrupole may include a plurality of quadrupole segments, each quadrupole segment being configured to generate an electric field that can be controlled independently of the other quadrupole segments. The plurality of quadrupole segments may be collectively configured to reduce a kinetic energy of the one or more ions as the one or more ions transit the length of the particle guide.

In some embodiments, the quadrupole may include at least four linear components disposed axially along the length of the conduit. A central passage may extend between the four linear components, and the central passage may be open such that the one or more ions may transit the length of the conduit by traveling through the central passage. The passage defined by the first vent may extend between two of the four linear components to the central passage.

In some embodiments, the particle guide may have a fluid conductance defined by an open cross-sectional area of the conduit and a length of the closed section, the fluid conductance being less than one liter per second.

In some embodiments, a sealing ring may be disposed between the closed section of the housing and the juncture between the first chamber and the second chamber. In some embodiments, a third chamber may have a third pressure that is less than the second pressure of the second chamber. In some embodiments, the particle guide may terminate at a lens gate disposed at a juncture between the second chamber and the third chamber, and the lens gate may be configured to selectively allow the one or more ions to enter the third chamber.

In some embodiments, a particle guide configured to be disposed in a mass spectrometer may be provided. The particle guide may be configured to be disposed in a mass spectrometer that includes a plurality of chambers having different pressures including at least a first chamber having a first pressure that is less than atmospheric pressure and a second chamber having a second pressure that is less than the first pressure. In some embodiments, the particle guide may include a conduit through which the one or more ions may travel an entire length of the particle guide. The conduit may be configured to be disposed within at least the first chamber and the second chamber. The particle guide may further include a housing surrounding the conduit. In some embodiments, the housing may include a first open section comprising a first vent that is configured to define a passage between the first chamber and the conduit when the first open section is disposed in the first chamber. The housing may further include a second open section comprising a second vent that is configured to define a passage between the second chamber and the conduit when the second open section is disposed in the second chamber. The housing may further include a closed section disposed between the first open section and the second open section. At least part of the closed section may be configured to be disposed at a juncture between the first chamber and the second chamber.

In some embodiments, the particle guide may include a quadrupole. The quadrupole may include a plurality of quadrupole segments, each quadrupole segment being configured to generate an electric field that can be controlled independently of the other quadrupole segments. The plurality of quadrupole segments may be collectively configured to reduce a kinetic energy of the one or more ions as the one or more ions transit the length of the particle guide.

In some embodiments, the quadrupole may include four linear components disposed axially along the length of the particle guide. A central passage may extend between the four linear components, the central passage being open such that the one or more ions may transit the length of the particle guide by traveling through the central passage. The passage defined by the first vent may extend between two of the four linear components to the central passage. In some embodiments, the closed section may have a fluid conductance defined by an open cross-sectional area of the central passage and a length of the closed section, the fluid conductance being less than one liter per second.

In some embodiments, a sealing ring may be disposed between the closed section of the housing and the juncture between the first chamber and the second chamber.

In some embodiments, the particle guide may terminate at a lens gate that is configured to be disposed at a juncture between the second chamber and a third chamber of the mass spectrometer. The third chamber may have a third pressure that is less than the second pressure of the second chamber. The lens gate may be configured to selectively allow the one or more ions to enter the third chamber.

In some embodiments, a method for analyzing a sample may be provided. In some embodiments, the method may be performed using a mass spectrometer including a plurality of chambers having different pressures including at least a first chamber having a first pressure that is less than atmospheric pressure and a second chamber having a second pressure that is less than the first pressure. In some embodiments, the method may include applying energy to the sample to generate one or more ions, transiting the one or more ions through a particle guide disposed at least partially in the first chamber and the second chamber of the mass spectrometer, and detecting an arrival of the one or more ions at a detector. In some embodiments, the particle guide may include a conduit through which the one or more ions may travel an entire length of the particle guide and a housing surrounding the conduit. In some embodiments, the housing may include a first open section comprising a first vent, the first vent being configured to define a passage between the first chamber and the conduit. The housing may further include a second open section comprising a second vent, the second vent being configured to define a passage between the second chamber and the conduit. The housing may further include a closed section disposed between the first open section and the second open section, at least part of the closed section being disposed at a juncture between the first chamber and the second chamber.

In some embodiments, a mass spectrometer may be provided. The mass spectrometer may include a source configured to output a plurality of particles which may include one or more charged particles and one or more uncharged particles. The mass spectrometer may further include a tube having a central axis, a deflector that is configured to be charged to deflect the one or more charged particles, and a skimmer. The skimmer may include an aperture arranged to receive the one or more charged particles deflected by the deflector, and a contact surface comprising an intersection point that intersects the central axis of the tube, the intersection point being spaced from the aperture by a distance of at least 5 mm. The mass spectrometer may further include a particle guide configured to transit the one or more charged particles along a length of the particle guide, and a detector configured to detect the one or more charged particles. In some embodiments, the one or more charged particles may be configured to: (i) travel through the tube toward the skimmer; (ii) be deflected by the deflector toward the aperture; (iii) travel through aperture and into the particle guide; (iv) transit the length of the particle guide; and (v) be detected by the detector. At least some of the one or more uncharged particles may be configured to: (i) travel through the tube toward the skimmer; and (ii) be deposited on the contact surface.

In some embodiments, a mass spectrometer filter assembly may provide one or more charged particles from a source. A pusher-detection chamber may receive the one or more charged particles from the mass spectrometer filter assembly. The pusher-detection chamber may include a pusher assembly and an ion detector. The pusher assembly may be disposed in the pusher-detection chamber at a first location. The detector may be disposed in the pusher-detection chamber at a second location.

In some embodiments, a time-of-flight (TOF) system may launch the one or more charged particles from the first location to the detector at the second location along a path using the pusher assembly. The system may determine a TOF for each of the one or more charged particles.

In some embodiments, the TOF system may include a high-voltage pulse generator, a pulse detector, a time domain calculator (TDC), a detection comparator, a start latch, a stop latch, and a control system. The high-voltage pulse generator may output a high voltage pulse to cause the pusher assembly to launch the one or more charged particles, in response to a signal from the control system. The pulse detector may detect the high voltage pulse and output a start signal. The TDC may determine the TOF for each of the one or more charged particles based on a stopwatch. The start latch may start the stopwatch of the TDC in response to receiving the start signal. The detection comparator may output stop signals when a signal from the detector is greater than a first threshold. A stop latch may indicate stops to the stopwatch of the time domain calculator in response to receiving the stop signals. A control system may control the high-voltage pulse generator, the start latch, and the stop latch, and receive the determined TOF for each of the one or more charged particles from the time domain calculator.

In some embodiments, the TOF system may include a high-voltage pulse generator, a TDC, a detection comparator, a start latch, a stop latch, and a control system. The high-voltage pulse generator may output a high voltage pulse to cause the pusher assembly to launch the one or more charged particles. The TDC may determine the TOF for each of the one or more charged particles based on a stopwatch. The detection comparator may output a timer signal when a signal from the ion detector is greater than a first or second threshold value (e.g., as controlled by the control system). A start latch may indicate a start to the stopwatch of the TDC in response to receiving the timer signals. A stop latch may indicate stops to the stopwatch of the TDC in response to receiving the timer signals. A control system may control the high-voltage pulse generator, the start latch, and the stop latch, and receive the determined TOF for each of the one or more charged particles from the time domain calculator.

Further variations encompassed within the systems and methods are described in the detailed description of the invention below.

### BRIEF DESCRIPTION OF THE DRAWINGS

FIG. 1 shows a schematic diagram of an exemplary mass spectrometer.

FIG. 2 shows a perspective view of certain components of a mass spectrometer.

FIG. 3 shows an exemplary particle guide.

FIGS. 4A and 4B show additional views of the particle guide shown in FIG. 3.

FIG. 5 shows a longitudinal cross-sectional view of the particle guide shown in FIG. 3.

FIGS. 6A-6C show exemplary skimmer arrangements for receiving ions.

FIG. 7 shows a perspective view of an exemplary skimmer.

FIG. 8 shows an exemplary method for analyzing a sample.

FIG. 9 shows an exemplary time-of-flight (TOF) system with pulse detection.

FIG. 10 shows an exemplary method of determining TOF using pulse detection.

FIG. 11 shows an exemplary TOF system with a detector coupled to a start latch and stop latch.

FIG. 12 shows an exemplary method of determining TOF using a detector coupled to a start latch and stop latch.

FIG. 13 shows an exemplary timing sequence of the TOF system.

FIG. 14 depicts an example system that may execute techniques presented herein.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

Time delays between initiation and reaction, which are inherent in any electronic processing path, may cause errors and/or uncertainties to the start and stop times, thus introducing errors and/or uncertainties in calculations based on the start and stop times. Such errors and/or uncertainties may result in errors and/or uncertainties when calculating the mass or charge of an ion. Examples of what can cause time delays may include long-term variances (e.g., thermal drift), phase noise, jitter, and/or the like.

A mass spectrometer filter assembly may provide one or more charged particles from a source. A pusher-detection chamber may receive the one or more charged particles from the mass spectrometer filter assembly. The pusher-detection chamber may include a pusher assembly and an ion detector. The pusher assembly may be disposed in the pusher-detection chamber at a first location. The ion detector may be disposed in the pusher-detection chamber at a second location.

A time-of-flight (TOF) system may launch the one or more charged particles from the first location to the ion detector at the second location along a path using the pusher assembly. The system may determine a TOF for each of the one or more charged particles, and use the TOF to determine one or more characteristics of the charged particles (e.g., mass and/or charge).

In some embodiments, the TOF system may include a high-voltage pulse generator, a pulse detector, a TDC, a detection comparator, a start latch, a stop latch, and a control system. The high-voltage pulse generator may output a high voltage pulse to cause the pusher assembly to launch the one or more charged particles, in response to a signal from the control system. The pulse detector may detect the high voltage pulse and output a start signal. The TDC may determine the TOF for each of the one or more charged particles based on a stopwatch. The start latch may start the stopwatch of the TDC in response to receiving the start signal. The detection comparator may output stop signals when a signal from the ion detector is greater than a first threshold. A stop latch may indicate stops to the stopwatch of the time domain calculator in response to receiving the stop signals. A control system may control the high-voltage pulse generator, the start latch, and the stop latch, and receive the determined TOF for each of the one or more charged particles from the TDC. In this case, the TOF system may avoid time jitter associated with the high-voltage pulse generator, as the pulse detector initiates the start time. In this manner, the uncertainty (e.g., due to time jitter of the high-voltage pulse generator) may be avoided. In some cases, time jitter of high-voltage pulse generators may be larger or more variable than other components of the TOF system, thus the TOF system may reduce overall errors and/or uncertainties by using a pulse detector.

In some embodiments, the TOF system may include a high-voltage pulse generator, a TDC, a detection comparator, a start latch, a stop latch, and a control system. The high-voltage pulse generator may output a high voltage pulse to cause the pusher assembly to launch the one or more charged particles, in response to a signal from the control system. The TDC may determine the TOF for each of the one or more charged particles based on a stopwatch. The detection comparator may output a timer signal when a signal from the ion detector is greater than a first or second threshold value (e.g., as controlled by the control system). A start latch may indicate a start to the stopwatch of the time domain calculator in response to receiving the timer signals. A stop latch may indicate stops to the stopwatch of the time domain calculator in response to receiving the timer signals. A control system may control the high-voltage pulse generator, the start latch, and the stop latch, and receive the determined TOF for each of the one or more charged particles from the time domain calculator. In this case, the TOF system may avoid time jitter associated with the high-voltage pulse generator and a pulse detector, as the pulse detector may sense and initiate the start and stop times. In this manner, the uncertainty (e.g., due to time jitter of the high-voltage pulse generator and the pulse detector) may be avoided. In some cases, time jitter of high-voltage pulse generators/pulse detectors may be larger or more variable than other components of the TOF system, thus the TOF system may reduce overall errors and/or uncertainties by using a pulse detector.

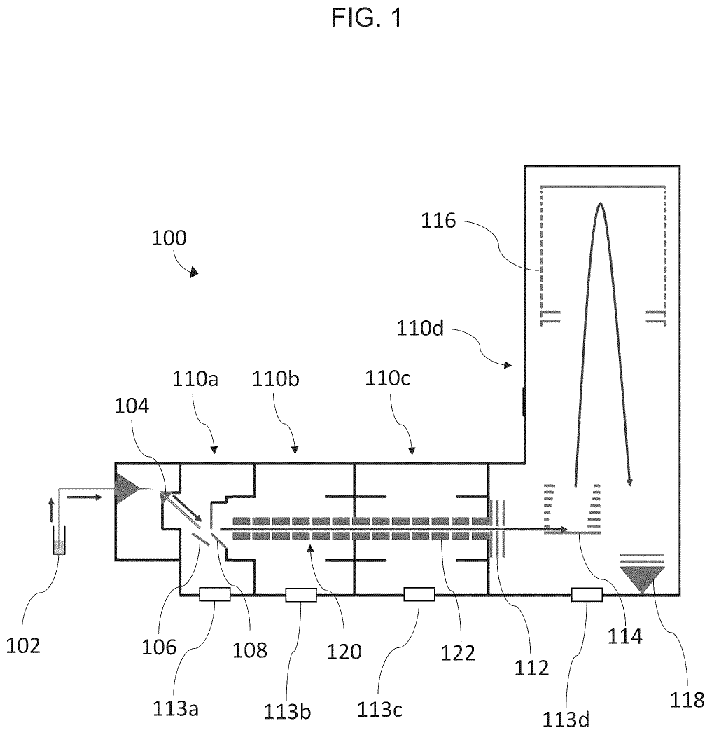

FIG. 1 shows a schematic diagram of an exemplary mass spectrometer 100. In some embodiments, the mass spectrometer 100 may include a plurality of chambers 110a, 110b, 110c, 110d, each of which may have a different pressure. For example, chamber 110a may have a pressure less than atmospheric pressure, and each of chambers 110b, 110c, 110d may have progressively lower pressures, such that chamber 110d has a sufficiently low pressure that air molecules will not affect (or will minimally affect) the flow of ions through the chamber 110d to a detector 118. In an exemplary embodiment, chamber 110a may have a pressure between 0.1 and 10 torr or, preferably, approximately 1 torr. Chamber 110b may have a pressure between 0.001 and 0.1 torr or, preferably, approximately 0.01 torr. Chamber 110c may have a pressure between 10⁻⁵ and 10⁻³ torr or, preferably, approximately 10⁻⁴ torr. Chamber 110d may have a pressure between 10⁻⁸ and 10⁻⁵ torr or, preferably, approximately 10⁻⁷ torr. In some embodiments, a greater or lesser number of chambers may optionally be provided, and the pressures in each chamber may optionally be varied from the values described herein.

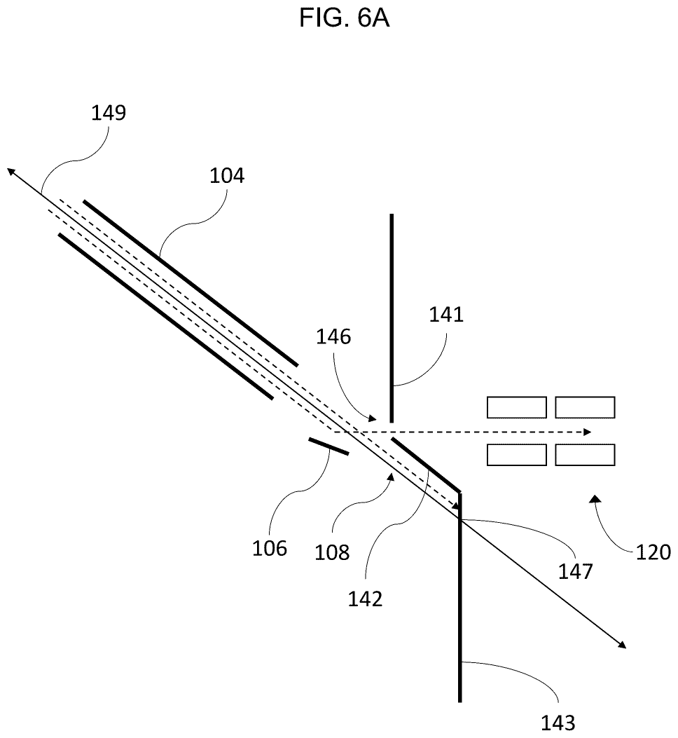

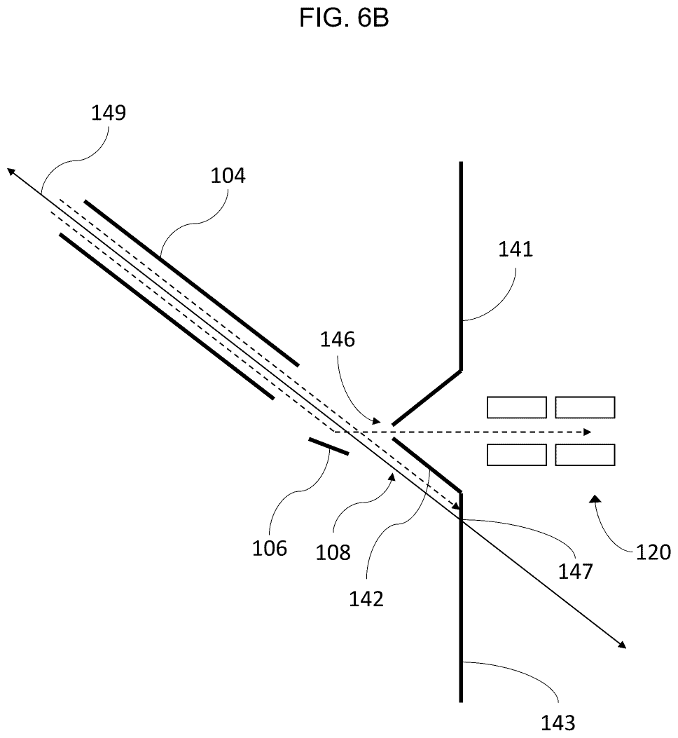

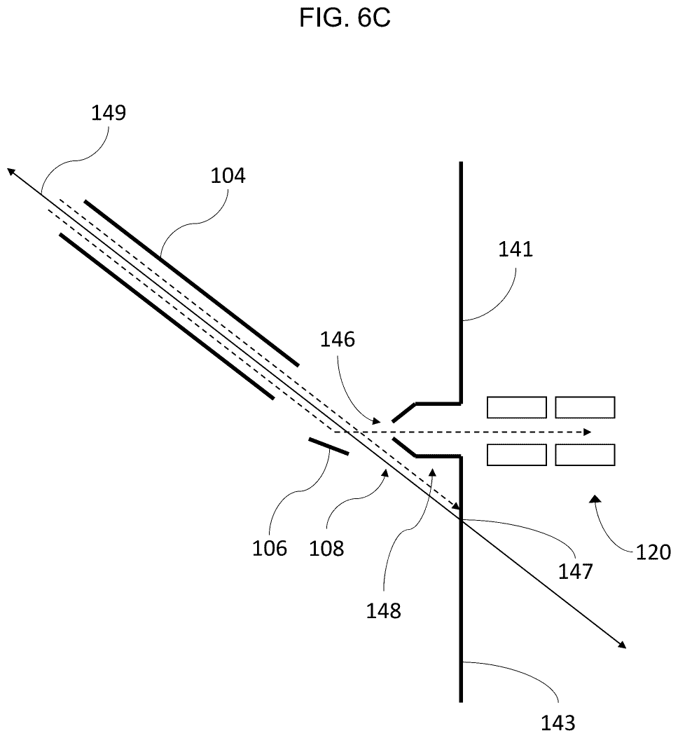

In some embodiments, mass spectrometer 100 may include a source 102 configured to output one or more ions. In some embodiments, the source 102 may include a chamber in which a sample may be received. The source 102 may further include a device for applying energy to and ionizing molecules in the sample. In some embodiments, the source may use capillary electrophoresis and/or electrospray ionization. In some embodiments, ions may flow from the source 102 to a tube 104. Ions may flow from the tube 104 may toward a deflector 106 and then to a skimmer 108. The skimmer 108 may allow ions that are on an intended path to travel into a particle guide 120. Ions that deviate from the intended path may be blocked by the skimmer and may be prevented from entering the particle guide 120. Exemplary skimmer arrangements are described in greater detail below with respect to FIGS. 6A-6C.

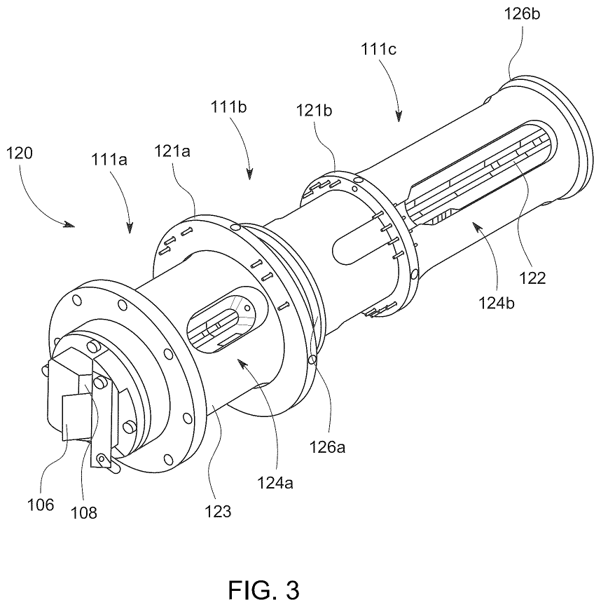

In some embodiments, the particle guide 120 may include a quadrupole, as described in greater detail below with respect to FIGS. 3-5. The particle guide may include a plurality of segments 122 which may apply electric fields to guide and manipulate the flow of ions through a length of the particle guide. FIG. 1 shows an exemplary particle guide with thirteen quadrupole segments. Particle guides may optionally have a greater or lesser number of segments than shown in this embodiment. The particle guide may terminate at a lens gate 112, which may selectively allow ions to pass into chamber 110d. In some embodiments, lens gate 112 may be affixed to or integrated with particle guide 120. In other embodiments, lens gate 112 may be adjacent to particle guide 120. Lens gate 112 may have a first state in which it is open to passage of ions from particle guide 120 to chamber 110d, and it may have a second state in which it blocks the flow of ions from particle guide 120 to chamber 110d. Lens gate 112 may be configured to selectively switch between the first state and the second state based on signals provided by a controller.

In some embodiments, mass spectrometer 100 may include a pusher 114, a reflectron 116, and a detector 118. Pusher 114 may include a plurality of conductive elements (e.g., stacked plates that are electrically isolated from one-another) which may be selectively charged at different voltages. Ions may be configured to travel from lens gate 112 to a channel within pusher 114, and the pusher 114 may generate an electric gradient that causes the ions to accelerate through the pusher channel toward reflectron 116. Reflectron 116 may include a plurality of conductive rings or other elements that can be selectively charged at different voltages, thereby generating an electric gradient that is configured to reflect ions toward detector 118. Detector 118 may be configured to detect the arrival of each ion that contacts the detector 118 and record a precise time of each arrival. In some embodiments, detector 118 may be a microchannel plate, which may be configured to detect individual ions.

In use, a sample may be placed in source 102 and energized to produce ions. The ions may flow from source 102 to tube 104, to deflector 106, and through skimmer 108 to particle guide 120. Ions may then travel through particle guide 120, which may confine the travel of ions and, in some embodiments, reduce their kinetic energy. Ions may then travel through lens gate 112 and to pusher 114. Ions may be accelerated by pusher toward reflectron 116 and then reflected toward detector 118, where their time of arrival may be recorded.

An ion's time of flight from pusher 114 to detector 118 may vary based on the mass and charge of the ion. For example, ions with greater mass may accelerate more slowly at pusher 114 and reflectron 116, resulting in a longer time of flight to detector 118. Greater charge, conversely, may produce higher acceleration, resulting in a shorter time of flight to detector 118. By accurately measuring the time from when the pusher 114 begins accelerating the ions and when those ions arrive at detector 118, the mass and charge of the ions may be inferred, and the composition of the sample at source 102 may be analyzed.

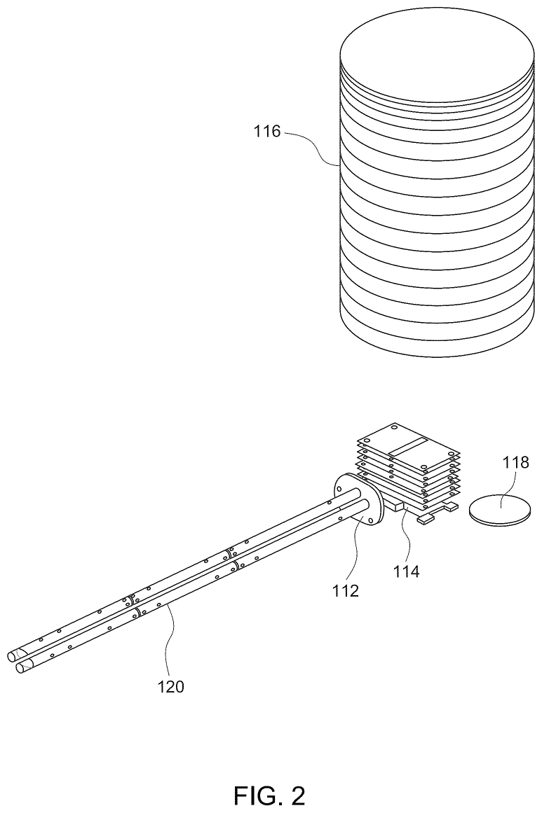

FIG. 2 shows a perspective view of certain components of a mass spectrometer. As described above in the schematic diagram shown in FIG. 1, FIG. 2 shows a particle guide 120, a lens gate 112, a pusher 114, a reflectron 116, and a detector 118.

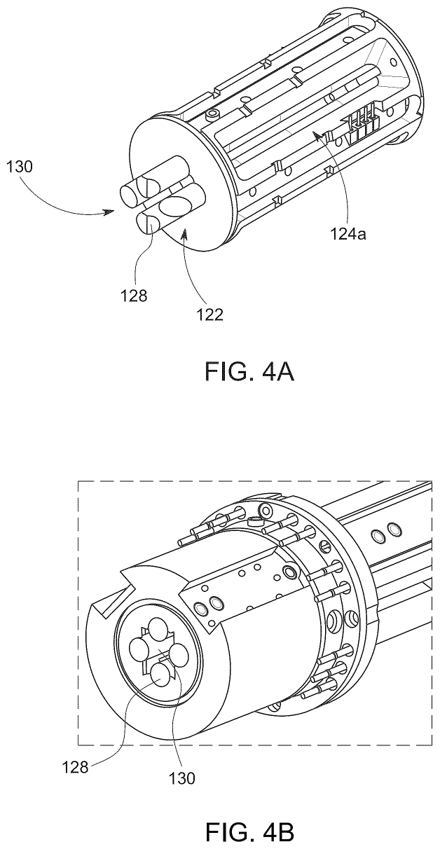

FIG. 3 shows an exemplary particle guide 120. Particle guide 120 may include a housing 123, which may enclose electrical components and provide a rigid support with which the particle guide 120 may be affixed within a mass spectrometer. A plurality of quadrupole segments 122 may be disposed within the housing 123. As shown in greater detail in FIGS. 4A and 4B, each quadrupole segment 122 may include four conductive members 128 which may be disposed around a central channel 130. The conductive members 128 may be selectively charged, such that the conductive members of a quadrupole segment, in conjunction with other quadrupole segments of the particle guide, may direct and manipulate the flow of ions through the central channel 130 of the particle guide. The central channel 130 may extend along an entire length of the particle guide.

In some embodiments, a deflector 106 and a skimmer 108 may be affixed to the particle guide. The deflector 106 and skimmer 108 may be configured to perform the functions described above with reference to FIG. 1 and below with reference to FIGS. 6A-6C.

The particle guide 120 may include sections 111a, 111b, 111c. In some embodiments, section 111a may be an open section that includes a vent 124a that provides a passage from an exterior of section 111a to the central channel 130. For example, the passage defined by vent 124a may extend between two of four conductors 128 of one or more quadrupole segments 122 in section 111a.

Section 111c may also be an open section. Section 111c may include a vent 124b that provides a passage from an exterior of section 111c to the central channel 130. For example, the passage defined by vent 124b may extend between two of four conductors 128 of one or more quadrupole segments 122 in section 111c. Section 111b may preferably be a closed section that does not include a vent. Additional open or closed sections may optionally be provided.

The particle guide 120, including sections 111a, 111b, 111c, may be disposed in a mass spectrometer having multiple chambers at different pressures. Section 111a may, for example, be disposed in a first chamber (such as chamber 110b in FIG. 1) having a first pressure, and section 111c may, for example, be disposed in a second chamber (such as chamber 110c in FIG. 1). Vent 124a may provide a passage from the first chamber to the central channel, and vent 124b may provide a passage from the second chamber to the central channel. Thus, the portion of the central channel near vent 124a may be equal or approximately equal to the pressure in the first chamber, and the portion of the central channel near vent 124b may be equal or approximately equal to the pressure in the second chamber.

A pressure differential may exist along the portion of the central channel spanning from the first vent 124a to the second vent 124b. The flow of air molecules may be limited by a fluid conductance of the closed section 111b. For example, a fluid conductance of the closed section 111b may be determined by a cross-sectional area of the opening in channel 130 and a length of the closed section. By making the fluid conductance sufficiently low (e.g., because the cross-sectional area is sufficiently small and the length of the closed section is sufficiently large), the flow of air from a higher-pressure chamber to a lower-pressure chamber may be reduced to a level that can be offset using a vacuum pump or other device, thereby maintaining the pressure differential at a desired state. In some embodiments, the length of the closed segment may be at least 1 cm, at least 40 cm, or, more preferably, at least 4 cm. In some embodiments, the open cross-sectional area of the channel 130 may be less than 0.05 cm², less than 5 cm², or, more preferably, less than 0.3 cm². In some embodiments, the fluid conductance of the closed section may be less than 0.01 liters per second, less than 10 liters per second, or more preferably, less than 1 liter per second. As illustrated in FIG. 1, one or more vacuum pumps 113a, 113b, 113c, 113d may be arranged to remove air molecules from chambers 110a, 110b, 110c, 110d respectively. The one or more vacuum pumps may be directly affixed to a housing of the mass spectrometer 100, or they may be coupled to the chambers via hoses. In some embodiments, the vacuum pumps may be roughing pumps, such as rotary vanes or scrolls, or a turbomolecular pump. In some embodiments, a higher-powered pump may be used for chambers 110b, 110c, and/or 110d than for chamber 110a. For example, a rotary vane may be connected to chamber 110a, and a three-stage turbo pump may be connected to chambers 110b, 110c, and 110d. Other pumping arrangements may be used.

When arranged in a mass spectrometer such as that shown in FIG. 1, open section 111a may be disposed in chamber 110b, open section 111c may be disposed in chamber 110c, and closed section 111b may be disposed across a juncture between chambers 110a and 110b. In this manner, a single particle guide may be disposed across multiple chambers at different pressures without producing unacceptable levels of gas flow across the chambers. This may advantageously reduce the number of separate particle guides that need to be provided and installed in a mass spectrometer, thereby reducing the cost of the mass spectrometer and improving the consistency and reliability of the device's performance.

Particle guide 120 may include one or more circumferential rings 121a, 121b, which may be configured to receive electrical contacts for controlling electric fields in the particle guide. In some embodiments, rings 121a, 121b may alternatively or additionally be used to provide mechanical supports against which the particle guide 120 may be affixed within a mass spectrometer. In some embodiments, the rings 121a, 121b may be replaced with mechanical supports having different geometries. For example, the supports may be protrusions extend for less than the full circumference of the housing or have flat outer surfaces (e.g., a triangular, rectangular, pentagonal, or hexagonal projection).

In some embodiments, particle guide 120 may also include one or more sealing rings 126a, 126b. Sealing rings 126a, 126b may be made from a deformable material such as rubber or an elastomeric polymer, such that a sealing connection may be formed when the sealing ring contacts a surface. In some embodiments, when the particle guide 120 is installed in a mass spectrometer, the sealing rings 126a, 126b may be aligned with and contact walls between adjacent chambers. For example, with reference to FIG. 1, sealing ring 126a may be disposed such that it contacts the inner surface of an aperture in the wall between chamber 110b and chamber 110c. Sealing ring 126b may be disposed such that it contacts the inner surface of an aperture in the wall between chamber 110c and chamber 110d.

FIGS. 4A and 4B show cross-sectional views of the particle guide 120 shown in FIG. 3. In these figures, housing 123 has been omitted to more clearly show interior components of the particle guide 120.

FIG. 4A shows open section 111a of the particle guide 120. Particle guide 120 may include one or more quadrupole segments 122, each of which may include four conductive members 128 to which a voltage may be applied. Four quadrupole segments are visible in the section of the particle guide shown in FIG. 4A. The quadrupole segments 122 may be disposed around a central channel 130, which may define a path through which ions may flow through the length of the particle guide. Vent 124a may form a passage from an exterior of the particle guide to an interior of the particle guide 120 and, more specifically, to the central channel 130.

FIG. 4B shows closed section 111b of the particle guide 120. The open cross-sectional area of central channel 130 can be seen in FIG. 4B. By increasing or decreasing this cross-sectional area, a fluid conductance of the closed section may be modified.

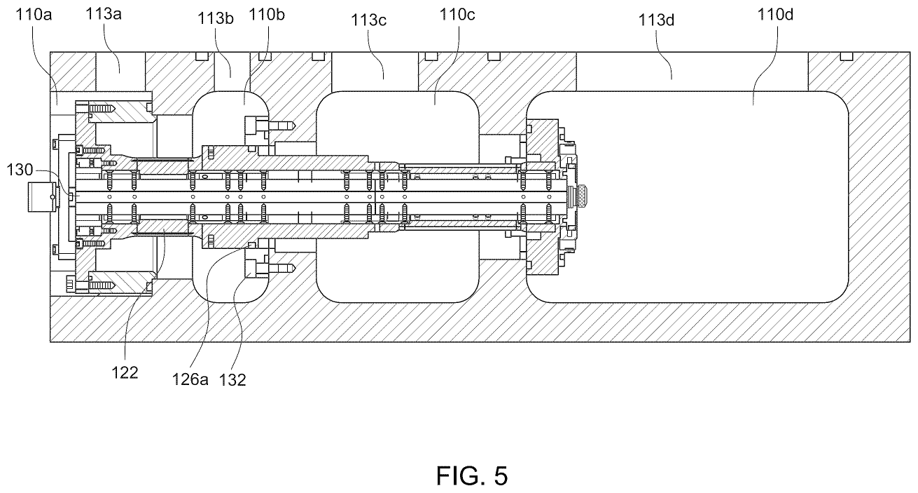

FIG. 5 shows a longitudinal cross-sectional view of the particle guide 120 as installed in the mass spectrometer shown in FIG. 1. As shown in FIG. 5, a mounting piece 132 may be affixed via bolts or other fixtures to a wall disposed between chambers 110b and 110c. The mounting piece 132 may be pressure fitted or otherwise coupled to housing 123 of the particle guide. Sealing ring 126 may be disposed between mounting piece 132 and housing 123 to provide an airtight seal between these components. The same or similar structures may be provided at other sections where the particle guide 120 is affixed to the mass spectrometer. For example, the same or similar structures may be provided at a distal end of particle guide 120 (e.g., around sealing ring 126b) where particle guide 120 may be affixed to a wall between chamber 110c and chamber 110d.

FIGS. 6A-6C show an exemplary skimmer arrangements for receiving ions. As shown in FIG. 6A, a skimmer arrangement may include one or more surfaces which may be geometrically arranged to reduce the risk of contamination surrounding an aperture 146. In the exemplary embodiment of FIG. 6A, a first surface 141 may be disposed at a nonzero angle relative to a second surface 143, and a third surface 143 may be disposed at a nonzero angle relative to the second surface 143. In some embodiments, the first surface 141 and the third surface 143 may be parallel to one-another or within 5 degrees of parallel to one-another. The second surface 142 may be disposed at an angle that is parallel to a central axis of tube 104. Alternatively, the second surface may be disposed at an angle that is closer to parallel to the central axis of tube 104 than are either of surface 141 or surface 143.

As described above with respect to FIG. 1, particles may generally flow from a source through a tube 104. As used herein, the term “particle” broadly includes collections of matter that can travel collectively as a unit through a mass spectrometer or portion thereof, and includes both individual molecules and larger groups of matter such as droplets, and may further include ions, heavy charged molecules or groups of matter, and neutral species. In some embodiments, tube 104 may be a capillary 104. A range of particles having different charge-to-mass ratios may enter the flowpath, where they may be deflected by a voltage on a deflector 106. As used herein, the term “deflector” broadly includes any element that has the purpose or effect of diverting a direction of a stream of charged particles, without regard to the element's geometry, and may include both flat and curved electrodes and other structures such as tubular lenses. Additionally, variations in particle trajectory may be observed.

Two exemplary, simplified flow paths are shown in dotted lines in FIG. 6A. In the case of a first particle path, the particle may be repelled by deflector 106 and directed through an aperture between in surface 141 or between surfaces 141 and 142 of skimmer 108 and into particle guide 120. A second particle may not be redirected or may be minimally redirected by deflector (e.g., due to low charge-to-mass ratio or misalignment) and may travel past the aperture and contact a surface 143 that is spaced a distance from the aperture. Surface 143 may include a point 147 that intersects a central axis 149 of tube 104. The geometry of the skimmer 108 may be such that point 147 is spaced a distance from aperture 146, and the central axis 149 has a clear path to point 147 (i.e., the central axis does not intersect another portion of skimmer 108 before reaching point 147). In some embodiments, the clear path may be such that a cylinder surrounding the central axis 149 having a radius of 1, 2, 3, or 5 mm may not intersect any portion of the skimmer until the cylinder reaches the point 147. In some embodiments, the distance between aperture 146 and point 147 may be at least 500 microns, at least 1 mm, at least 3 mm, at least 5 mm, at least 10 mm, at least 20 mm, at least 50 mm, or at least 100 mm.

FIGS. 6B and 6C show additional exemplary skimmer geometries. As shown in FIG. 6B, surface 142 may be a portion of a cone that extends toward or includes aperture 146. As shown in FIG. 6C, the aperture 146 may be disposed on an extension 148 or other surface that is spaced from surface 143. Optionally, the extension or spaced surface may include a cone or other portion having a surface that is substantially parallel to a central axis of tube 104. In other embodiments, this may be omitted, and the geometry of the extension or spaced surface may be used to ensure that uncharged particles which present a contamination risk predominantly travel a distance from the aperture 146. As in FIG. 6A, the geometries of the skimmer embodiments shown in FIGS. 6B and 6C may be such that point 147 is spaced a distance from aperture 146, and the central axis 149 has a clear path to point 147. The distance between aperture 146 and point 147 may be at least 500 microns, at least 1 mm, at least 3 mm, at least 5 mm, at least 10 mm, at least 20 mm, at least 50 mm, or at least 100 mm.

By angling surface 142 as shown in FIGS. 6A and 6B, particles that are not redirected or are minimally redirected by deflector will tend to travel a distance away from the aperture before contacting the skimmer. Alternatively, by using a projection or other spaced surface as sown in FIG. 6C, particles that are not redirected or are minimally redirected by deflector may likewise tend to travel a distance away from the aperture before contacting the skimmer. In some embodiments, at least 50%, at least 75%, at least 85%, at least 90%, at least 95%, at least 97%, at least 99%, or at least 99.5% of the uncharged particles that travel through the tube and are deposited on the skimmer may be deposited at least a distance from the aperture. In some embodiments, the distance may be at least 500 microns, at least 1 mm, at least 3 mm, at least 5 mm, at least 10 mm, at least 20 mm, at least 50 mm, or at least 100 mm. This may beneficially reduce the rate at which misaligned particles contact and are deposited on or around the aperture, where they can potentially become dislodged during future measurements and enter the particle guide. Notably, contamination issues are most frequently caused by droplets and heavy charged or neutral particles, which are not redirected or only minimally redirected by deflector 106. These particles may therefore reliably travel away from the aperture to surface 143, where they present little risk of contaminating future measurements. Accordingly, the skimmer arrangements shown in FIGS. 6A-6C may reduce the risk that deposited particles contaminate future measurements, thereby improving the accuracy and reliability of the mass spectrometer. Neutral gas molecules that travel through the tube may be predominantly pumped out of the mass spectrometer by a vacuum pump, rather than being deposited on a surface. While some heavier molecules may in theory be suspended in air traveling through the mass spectrometer and to deposit on surfaces within the mass spectrometer, this phenomenon has been found to cause minimal contamination.

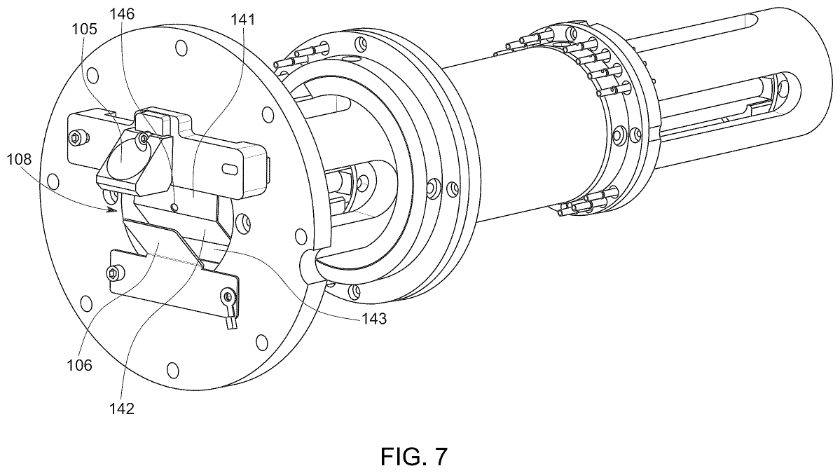

FIG. 7 shows a perspective view of an exemplary skimmer 108. As shown in FIG. 7, particles may approach skimmer 108 by traveling through a capillary disposed in recess 105. A voltage may be applied to deflector 106 such that deflector 106 may redirect charged particles as the exit the capillary. Charged particles may be redirected by deflector 106 into aperture 146 in surface 141, from which the particles may travel through a particle guide, such as the particle guides described above.

In some embodiments, surface 142 may be substantially parallel to a central axis of tube 104. For example, surface 142 may be within 30° of parallel to the central axis of tube 104, 20° of parallel to the central axis of tube 104, within 15° of parallel to the central axis of tube 104, 10° of parallel to the central axis of tube 104, within 8° of parallel to the central axis of tube 104, within 6° of parallel to the central axis of tube 104, within 4° of parallel to the central axis of tube 104, within 2° of parallel to the central axis of tube 104, or within 1° of parallel to the central axis of tube 104. In some embodiments, a distance between aperture 146 and the portion of surface 142 that is most proximate to aperture 146 may be less than 10 mm, less than 5 mm, less than 1 mm, less than 500 microns, less than 100 microns, less than 50 microns, or less than 10 microns.

Uncharged particles and particles with high mass-to-charge ratio may continue to travel along a path substantially parallel to the length of the capillary and may contact surface 143. These particles (and constituents thereof) may therefore be deposited a distance from aperture 146 and may present little risk of contaminating future measurements.

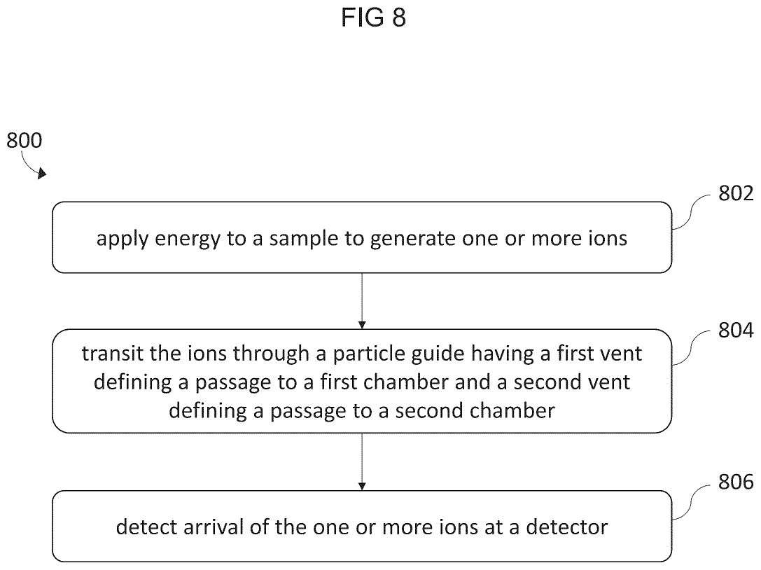

FIG. 8 shows an exemplary method 800 for analyzing a sample. Method 800 may be performed using a mass spectrometer having a particle guide as generally described above with respect to FIGS. 1-5. For example, method 800 may be performed using a mass spectrometer having a plurality of chambers having different pressures including at least a first chamber having a first pressure that is less than atmospheric pressure and a second chamber having a second pressure that is less than the first pressure. The mass spectrometer may include a particle guide including a conduit through which the one or more ions may travel an entire length of the particle guide and a housing surrounding the conduit. The housing may define a first open section comprising a first vent, the first vent being configured to define a passage between the first chamber and the conduit, a second open section comprising a second vent, the second vent being configured to define a passage between the second chamber and the conduit, and a closed section disposed between the first open section and the second open section.

In step 802, energy may be applied to a sample to generate one or more ions. For example, capillary electrophoresis and/or electrospray ionization may be used to generate the ions. Ions may then flow from the sample toward the particle guide, optionally via one or more of a capillary, a deflector, and/or a skimmer. In step 804, the ions may be transited through the length of a particle guide. The particle guide may be disposed across multiple chambers of the mass spectrometer at different pressures. In some embodiments, the particle guide may have a first vent defining a passage to the first chamber of the mass spectrometer and a second vent defining a passage to the second chamber of the mass spectrometer. To reduce the flow of air molecules along a pressure differential between the chambers, the vents may be spaced by a closed section having a cross-sectional area and length selected to provide a sufficiently low fluid conductance. To maintain the desired pressure states, the chambers of the mass spectrometer may additionally be continuously or intermittently evacuated using a vacuum pump.

In step 806, a detector may detect an arrival of the ions at the detector. In some embodiments, the detector may be configured to detect the arrival of each ion that contacts the detector and record a precise time for each arrival. In some embodiments, detector may be a microchannel plate. In some embodiments, a time between when a pusher begins accelerating the ions and when those ions arrive at the detector may be analyzed to determine a composition of the sample.

### TOF System Using Pulse Detection

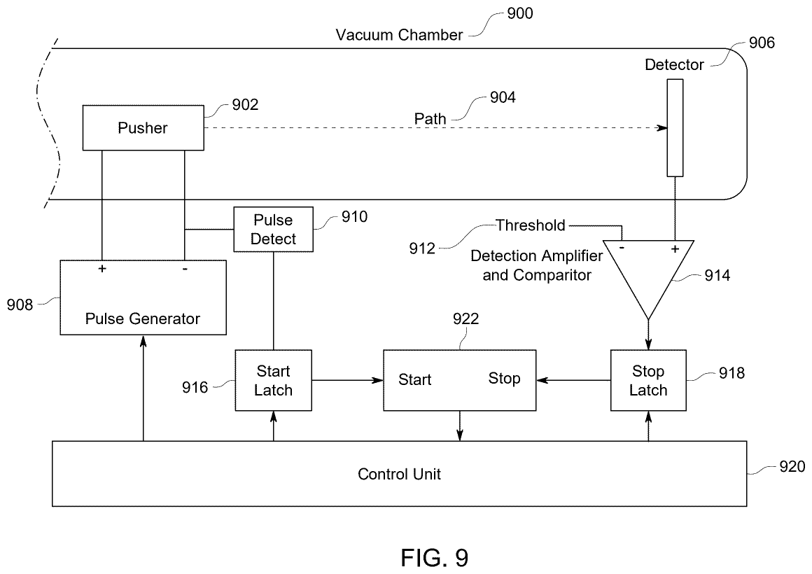

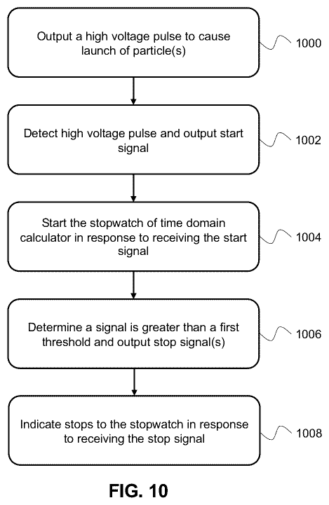

FIGS. 9 and 10 depict features a time-of-flight system (TOF system) using pulse detection. The feature of the TOF system using pulse detection of FIGS. 9 and 10 may apply to any of FIGS. 1, 2, 3, 4A-4B, 5, 6A-6C, 7, 8, 13, and 14. FIG. 9 shows an exemplary time-of-flight (TOF) system with pulse detection. As shown in FIG. 9, the system may include a vacuum chamber 900, a pusher 902, a path 904, an ion detector 906, a pulse generator 908, a pulse detector 910, a threshold 912, a detection amplifier and comparator 914, a start latch 916, a stop latch 918, and a control unit 920. Control system and control unit 920 may be used interchangeably herein.

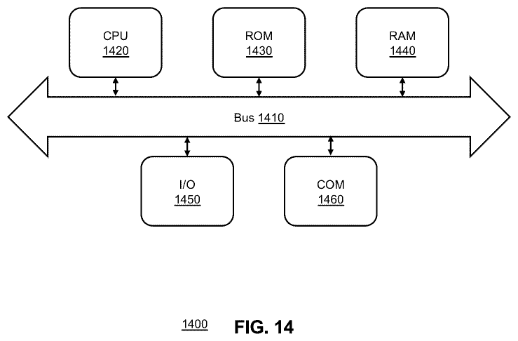

A control unit 920 may be used to initialize a launch of charged particles from the pusher 902. The control unit 920 may be a computer with a microprocessor. It may be capable of high-speed logic sequencers. It may include one or more of the features described with respect to FIG. 14. It may send a trigger signal to the pulse generator 908 which may signal the pulse generator 908 to set potentials that create a high-intensity electric field at the pusher 902 which will eject the charged particles. The trigger signal may be a logical style electric signal. For example, digital logic may be incorporated where an output voltage from the control unit 920 above a voltage value may indicate “true” and an output voltage from the control unit 920 above a voltage value may indicate “false.”

The particles may be ions whose mass and/or charge are unknown and the mass and/or charge be calculated using TOF. In some embodiments, any molecule with an electrical charge may be used by the system to determine characteristics of a molecule using TOF.

The particles may be launched by the pusher 902 and may follow the path 904 until they hit the ion detector 906. The pusher 902 may be a pusher assembly and may be included within a vacuum chamber 900. The pusher 902 may have electrode structures, which include one or more electrodes, that position the particles in preparation of launching them to the ion detector 906. The electric fields of the electrodes may facilitate control over such positioning.

The particles may be launched when the pusher 902 applies a high-intensity electric field which may repel the particles along the path 904 toward the ion detector 906. The pulse generator 908, which may be a high-voltage pulse generator, may set potentials that result in a high-intensity electric field associated with the pusher 902.

An output of the pulse generator 908 may be used to indicate when the particles are launched, which may be referred to as a “start” time. A pulse detector 910 may be coupled to the pulse generator 908 by capacitive or inductive means. The pulse detector 910 may determine that the pulse generator 908 generated a high-intensity electric field ready to repel the particles to the ion detector 906. Upon this determination, the pulse detector 910 may output a start signal to the start latch 916 to indicate “start.” A timestamp associated with the “start” may be recorded. The pulse detector 910 may be a high-voltage pulse detection circuit designed to minimize jitter within the system. For example, the pulse detector 910 may have a time jitter less than 10⁻¹⁰⁰ picoseconds (ps). For instance, the pulse detector 910 may have a time jitter less than any one of more of the following: 10 ps, 20 ps, 30 ps, 40 ps, 50 ps, 60 ps, 70 ps, 80 ps, 90 ps, or 100 ps (or any combination of ranges between such values). The pulse detector 910 may result in less time delay or uncertainty than if the start indication started when the pulse generator 908 generated the high-intensity electric field due to the pulse detector 910 having low latency or lower uncertainty in response time as compared to the pulse generator 908. For example, the pulse detector 910 may have a response time under 500-2000 nanoseconds. In some cases, the pulse detector 910 may have a time jitter less than 10% of a time jitter of the pulse generator 908. In some cases, the pulse detector 910 may have a time jitter less than 10%, 9%, 8%, 7%, 6%, 5%, 4%, 3%, 2%, 1%, 0.9%, 0.8%, 0.7%, 0.6%, 0.5%, 0.4%, 0 3%, 0.2%, or 0.1% (or any combination of ranges between such values) of a time jitter of the pulse generator 908.

Capacitive means may include the pulse detector 910 having a capacitive sensing component. The capacitive sensing component may be capacitively coupled to an electrical pathway that transmits the high voltage pulse between the high-voltage pulse generator 908 and the pusher assembly 902. The capacitive sensing component may include a plate coupled to a negative terminal which may act to accept electrons form a source, a plate coupled to a positive terminal which may act to release electrons to the source, and a source that produces a current that flows through the plates of the capacitor, forming a circuit. As the current flows between the plates, which are often metal plates or semiconductor structures (e.g., silicon, silicon-oxide layers), the capacitor may store energy in the form of a voltage difference. The capacitive sensing component may detect the high voltage pulse between the high-voltage pulse generator 908 and the pusher assembly 902 by sensing changes in the current flow or changes in the voltage difference due to the high voltage pulse passing near the capacitive sensing component via the electrical pathway. In some cases, the capacitive sensing component may include a filter or trigger condition to discriminate between noise and the high-voltage pulse.

Inductive means may include the pulse detector 910 having an inductive sensing component. The inductive sensing component may be inductively coupled to an electrical pathway that transmits the high voltage pulse between the high-voltage pulse generator 908 and the pusher assembly 902. The inductive sensing component may include an inductive wiring (e.g., antenna, coil, trace, and the like) coupled to a circuit. The inductive sensing component may sense any change in current flowing through the inductive wiring/circuit due to the high voltage pulse between the high-voltage pulse generator 908 and the pusher assembly 902. In some cases, the inductive sensing component may include a filter or trigger condition to discriminate between noise and the high-voltage pulse.

The particles may travel along a path to the ion detector 906. The path 904 may be a fixed length. For instance, the path 904 may be designed to traverse from the pulse generator 908 to the reflectron 116 (see FIG. 1), and then from the reflectron 116 to the ion detector 906. The time it takes, which may be referred to as TOF, for the particles to travel from the pusher 902 to the ion detector 906 may be used to calculate the mass, charge, and/or other characteristics of the particles. In some embodiments, both the charge and the electric field strength that launches the particles may be set to a constant. In such a case, the TOF may be directly related to the mass of the particle and may be used by the control unit 920 to determine the mass. As described herein, a precise measurement of TOF may lead to an accurate determination of the mass. Any noise such as thermal drift, phase, jitter, and/or the like that creates uncertainty in the measurement may lead to an inaccurate determination of the mass. For example, time delays between initiation and reaction may erroneously be added to the TOF, which may result in uncertainty.

The ion detector 906 may record the particles as they strike. A high-speed latch may be used to record the strike. In some embodiments, the ion detector 906 may be linked to memory capable of indexing the strike and data related to the strike. The output signal of the ion detector 906, when a particle strikes the ion detector 906, may be a short, low voltage electrical pulse. For example, the pulse may be sub-nanoseconds long. In some cases, the ion detector 906 may output spurious low-level background noise. In these cases, various components of TOF systems may filter or latch components to not respond to signals from the ion detector 906 that correspond to background noise.

A detection amplifier and comparator 914 may include an amplifier and a comparator. The amplifier may be used to buffer the output signal from the ion detector 906. For instance, the amplifier may buffer short, low voltage electrical pulses from the ion detector 906 so that the comparator may make determinations, as discussed herein. The amplifier may be a high-speed amplifier. The amplifier may include a filtering function such as a nonlinear filtering function to filter (e.g., smooth, high-pass, low-pass, and the like) the output signal prior to further processing.

The comparator may be coupled to the amplifier and used to assess whether the amplified output signal exceeds a threshold 912. The threshold 912 may be preconfigured to the comparator by the control unit 920. The threshold 912 may be used by the system to differentiate output signals from the ion detector 906 associated with particle strikes from signals associated with background noise.

A time domain calculator 922 (TDC 922) may a part of or separate from the control unit 920. The TDC 922 may act as a stopwatch. In some embodiments, the TDC 922 may function as an accurate, high-speed stopwatch. Upon the pulse detector 910 detecting that the high-intensity electric fields generated by the pulse generator 908, thereby indicating a start of the process to repel the particles, an input signal may be sent to a start latch 916 to indicate “start.” The TDC 922 may record a timestamp associated with the start, based on a signal from the start latch 916. The control unit 920 may access and read the timestamp. In response to a determination that an output signal has crossed the threshold, an input signal may be sent to the stop latch 918 to indicate “stop.” In some embodiments, a leading edge of a latch output may signal the “stop.” In some embodiments, the stop latch 918 may stretch the output signal from the ion detector 906, via the comparator 914, to allow time for the TDC to recognize the stop signal. The TDC 922 ma record a timestamp associated with the “stop.” The control unit 920 may access and read the timestamp. In some embodiments, the control unit 920 may be sent, via a message, the timestamp along with information related to the timestamp. Using the timestamps, the control unit 920 may calculate TOF, and the control unit 920 may calculate the particle mass using the TOF. After the mass is calculated, the control unit 920 may reset the stop and start latches.

FIG. 10 shows an exemplary method of determining TOF using pulse detection. A mass spectrometer may include a mass spectrometer filter assembly, a pusher-detection chamber, and/or a TOF system.

The mass spectrometer filter assembly may provide one or more charged particles from a source. The filter assembly may include one or more components described herein. For example, it may include a tube, a deflector-skimmer assembly, a particle guide, and/or the like.

The pusher-detection chamber may receive the one or more charged particles from the filter assembly. The pusher-detection chamber may be the vacuum chamber described with respect to FIG. 9. The pusher-detection chamber may include a pusher assembly and a detector. The pusher assembly may be and may include the characteristics of the pusher described with respect to FIG. 9. The detector may be and may include the characteristics of the detector described with respect to FIG. 9.

The TOF system may launch the one or more charged particles to the detector along a path using the pusher assembly, as described, e.g., with respect to FIG. 9. A TOF may be determined for each of the charged particles. The TOF system may include a pulse generator, a pulse detector, a TDC, a start latch, a detection comparator, a stop latch, and a control system, as described, e.g., with respect to FIG. 9. At 1000, the pulse generator may output a high voltage pulse, which may cause the launch of the charged particles. At 1002, the pulse detector may detect the high voltage pulse and output a start signal. At 1004, a start latch may receive the start signal and start a stopwatch associated with the TDC. At 1006, the detection comparator may determine that a signal (e.g., outputted by the ion detector, when a charged particle strikes the ion detector 9) is greater than a first threshold. Based on this determination, the detection comparator may output a stop signal. At 1008, a stop latch may receive the stop signal and indicate a stop(s) to the stopwatch associated with the TDC. Additional features of FIG. 9 may be incorporated into the steps 1000-1008 of FIG. 10.

TOF System with an Ion Detector Coupled to a Start Latch and Stop Latch

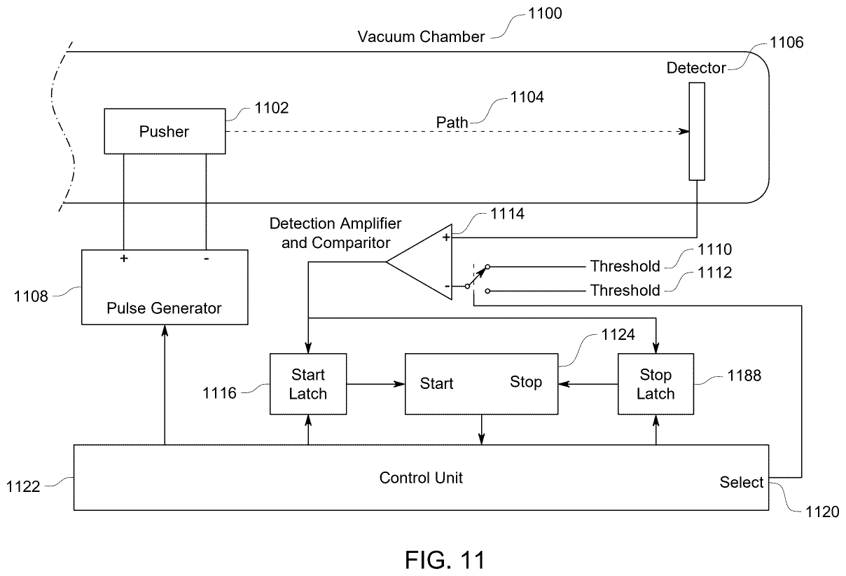

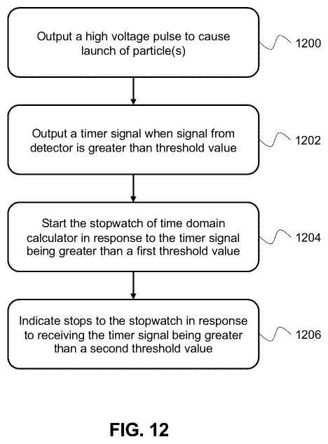

FIGS. 11 and 12 depict features a TOF system with a detector coupled to a start latch and stop latch. The feature of the TOF system with a detector coupled to a start latch and stop latch of FIGS. 11 and 12 may apply to any of FIGS. 1, 2, 3, 4A-4B, 5, 6A-6C, 7, 8, 13, and 14. FIG. 11 shows an exemplary TOF system with a detector coupled to a start latch and stop latch. As shown in FIG. 11, the TOF system may include a vacuum chamber 1100, a pusher 1102, a path 1104, an ion detector 1106, a pulse generator 1108, one or more thresholds (e.g., a high threshold 1110 and a low threshold 1112), a detection amplifier and comparator 1114, a start latch 1116, a stop latch 1118, a threshold selector 1120, and a control unit 1122. As described herein, both starting the TOF and stopping the TOF using the start latch 1116 and stop latch 1118, respectively, may follow a common signal path. For example, the signal path may start with the ion detector 1106, then run through the amplifier and comparator 1114, and then reach the latches. The TOF system, described herein, may have fewer components that could cause issues with time delays (e.g., components that produce jitter). The amplifier and comparator 1116 may be designed and optimized to minimize jitter.

The ion detector 1106 may be configured to be able to detect a range of electric fields and produce a voltage pulse corresponding to the detected electric field. The ion detector 1106 may be able to detect the high-intensity electric fields generated by the pulse generator 1108 and produced by the pusher 1102, both of which are described with respect to FIG. 9. In response to detecting the high-intensity electric fields, the ion detector 1106 may produce a voltage pulse which may be greater than the voltage pulse produced when it detects a charged particle, which may be described with respect to FIG. 9. The ion detector 1106 may be coupled to the amplifier and comparator 1114, which are described with respect to FIG. 9.

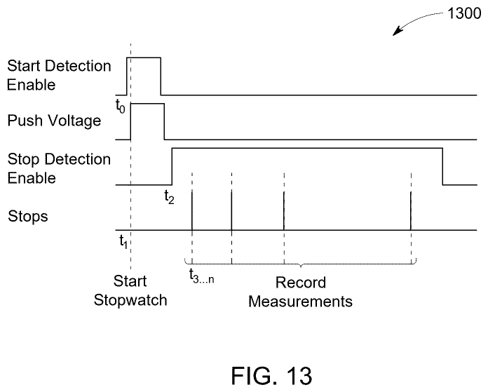

In anticipation of beginning a TOF measurement cycle, the control unit 1122 may set (e.g., to a start state, such as by resetting from a previous measure) both the start and stop latches. The control unit 1122 may hold both latches in this reset state as it prepares the rest of the system in anticipation of the launch of a charged particle. The control unit 1122 may hold and release the latches based on a defined timing sequence described with respect to FIG. 13.

Multiple thresholds may be coupled to the amplifier and comparator 1114. One of the thresholds may be used to determine if a voltage pulse produced by the ion detector 1106 corresponds to a high-intensity electric field generated by the pulse generator 1108. This threshold may be set higher than a threshold used to detect a charge particle strike described with respect to FIG. 9. The high threshold 1110 may be referred to as a push threshold and the low threshold 1112, described herein, may be referred to as an ion threshold. In some cases, the push threshold may be the same as the ion threshold; in these cases, the system may select a threshold that will detect pushes and ion strikes, but does not trigger based on noise; thus, in this cases, the system does not need to switch reference voltages (thereby reducing failure points). In some cases, the push threshold may be 100% larger than the ion threshold. In some cases, the push threshold may be 0%, 10%, 20%, 30%, 40%, 50%, 60%, 70%, 80%, 90%, 100%, 110%, 120%, 130%, 140% or 150% larger than the ion threshold. Generally, the push threshold and ion threshold may be selected based on statistics and noise characteristics of the ion detector 1106 and the detection amplifier and comparator 1114, i.e., as long as signals may be discerned within a threshold level of accuracy (e.g., 99%, 99.9%, 99.99% confidence). The threshold selector 1120, e.g., which may also be referred to as threshold switch, may be switch to the threshold that the comparator should compare an amplified output signal to, as described herein. The threshold selector 1120 may be managed by the control unit 1122. The threshold selector 1120 may switch between the high threshold 1110 and the low threshold 1112 based on a defined timing sequence. The high threshold 1110 may be greater than the low threshold 1120 by at least 10%.

The control unit 1122 may set the comparator to use the high threshold 1110 when initiating the pusher launch. For example, the control unit 1122 may determine based on the defined timing sequence to signal the threshold switch to switch to the high threshold 1110 before high-intensity electric pulse is generated by the pulse generator 1108. Additionally, the control unit 1122 may send a signal to the start latch 1116, e.g., while keeping the stop latch 1118 in a reset state, that allows the start latch 1116 to record a detection pulse. The signal may be used as a key to be exchanged between the start latch 1116 and the stop latch 1118, which may prevent false detections by either latch. The signal may be a counter clear (CLR) signal. The control unit 1122 may initiate the launch and trigger the pulse generator 1108, which may be described with respect to FIG. 9. The high-intensity launch pulse may be sent by the pusher 1102, and as a result may cause an electromagnetic wave to travel to and be detected by the ion detector 1106. In some embodiments, the pusher 1102 may be coupled to the ion detector 1106 and the high-intensity launch pulse may directly couple some energy into the ion detector 1106. As described herein, the ion detector 1106 may respond by producing a high voltage output pulse. The control unit 1122 may keep the stop latch 1118 in a reset state to prevent the stop latch 1118 from responding to false detections, the high voltage output pulse, or the background noise. For example, keeping the stop latch 1188 in a reset state may prevent the stop latch 1118 from responding to any activity associated with the launch of the high-intensity launch pulse, such as when the voltage of the high-intensity launch pulse deactivates. To keep the stop latch 1118 in the reset state, controller masking may be used by the control unit 1122.

The output pulse may be amplified as described with respect to FIG. 9. In some embodiments, additional amplification techniques may be used on the output pulse based on the output pulse being associated with a high voltage. The amplified output pulse may be compared, by the comparator, to the high threshold 1110 described above. If the amplified output pulse exceeds the high threshold 1110, the start latch 1116 may be set and the TDC 1124 (a part of or separate from the control unit 1122) coupled to the control unit 1122 may begin the timing measurement. In some embodiments, the comparator may output a timer signal when the output pulse exceeds the high threshold 1110. The timer signal may be received by the start latch 1116, which may indicate to start a stopwatch of TDC 1124, which may be described with respect to FIG. 9. The control unit 1122 may signal to the threshold selector 1120 to switch from the high threshold 1110 to the low threshold 1112. The control unit 1122 may determine based on a defined timing sequence to signal to the threshold switch to switch to the low threshold 1112 before releasing the stop latch 1118. In such a case, the comparator may compare output signals following the switch to the low threshold 1112. The low threshold 1112 may be used to determine when a charged particle strikes the ion detector 1106 as described with respect to FIG. 9. After the output pulse is deactivated, a signal may be sent to the stop latch 1118 to allow the stop latch 1118 to record a detection pulse. As described above, the signal may be a CLR signal. In some embodiments, the comparator may output a timer signal when the output pulse exceeds the low threshold 1112. The timer signal may be received by the stop latch 1118, which may indicate to stop a stopwatch of TDC1124, which may be described with respect to FIG. 9. The control unit 1122 may receive timestamps associated with the start and stop of the TDC and calculate a TOF of the charged particle, which may be described with respect to FIG. 9.

FIG. 12 shows an exemplary method of determining TOF using a detector coupled to a start latch and stop latch. A mass spectrometer may include a mass spectrometer filter assembly, a pusher-detection chamber, and/or a TOF system, all of which may have characteristics described with respect to FIGS. 10 and 11.

The TOF system may launch the one or more charged particles to the detector along a path using the pusher assembly, which may be described with respect to FIGS. 9 and 11. A TOF may be determined for each of the charged particles. The TOF system may include a pulse generator, a TDC, a start latch, a detection comparator, a stop latch, and a control system, all of which may be described with respect to FIG. 11. At 1200, the pulse generator may output a high voltage pulse, which may cause the launch of the charged particles. At 1202, a detector may output a signal (e.g., based on detection of the high voltage pulse as described with respect to FIG. 11). If the outputted signal is greater than a threshold value, the detection comparator may output a timer signal. At 1204, the start latch may receive the timer signal and indicate a start to a stopwatch associated with the TDC 1124. At 1206, stop latch may receive the timer signal and indicate a stop(s) to the stopwatch associated with the TDC1124, based on ion strikes of the ion detector 1106. Additional features of FIG. 11 may be incorporated into the steps 1200-1206 of FIG. 12.

### Timing Sequence

FIG. 13 shows an exemplary timing sequence 1300 of the TOF system. The timing sequence described herein may be incorporated with one or more techniques described with respect to FIG. 11. As shown in FIG. 13, the sequence 1300 may include a start detection, a push voltage, a stop detection, start stopwatch, one or more stops, and one or more record measurements.

At t0, the control unit may signal the start detection to be enabled. As described with respect to FIG. 11, the control unit may send a signal, such as a CLR signal, to the start latch, which may release the start latch from the reset state and allow the start latch to begin recording detections.

At t1, the pusher may send the high-intensity pulse generated by the pulse generator to the detector. The detector may output a high-intensity voltage which may be amplified. The comparator may determine that the high-intensity voltage exceeds a high threshold such as a push threshold. Based on this determination, the control unit may begin the stopwatch as described with FIG. 11.

At t2, the output voltage associated with the high-intensity electric field may drop to zero. In some embodiments, the output voltage may be deactivated, for example, by means external to the system. In some embodiments, the output voltage may be deactivated, for example, by a component of the system. In response to the output voltage dropping to zero, the control unit may enable the stop detection. In some cases, the control unit may detect the output going to zero (or near zero). In some cases, the control unit may know the output goes to zero (or near zero) at a predetermined amount of time from when the push voltage starts. For example, the control unit may send the signal, such as the CLR signal, to the stop latch, thereby releasing the stop latch, which may allow it to record detections to follow. The control unit may signal to the threshold switch to switch from the high threshold to the low threshold (e.g., ion threshold). The switch may occur before enabling stop detection.

At t3 through tn, the comparator may determine that the voltage produced by the detector indicate a respective charged particle strike based on the voltage exceeding the low threshold. Based on this determination, the control unit may signal a stop to the stopwatch. As described herein, timestamps associated with the start and stops of the stopwatch may be recorded and used by the control unit to calculate the TOFs of each respective charged particle.

### Computer System

FIG. 14 depicts an example system that may execute techniques presented herein. FIG. 14 is a simplified functional block diagram of a computer that may be configured to execute techniques described herein, according to exemplary cases of the present disclosure. Specifically, the computer (or “platform” as it may not be a single physical computer infrastructure) may include a data communication interface 1412 for packet data communication. The platform may also include a central processing unit (“CPU”) 1402, in the form of one or more processors, for executing program instructions. The platform may include an internal communication bus 1408, and the platform may also include a program storage and/or a data storage for various data files to be processed and/or communicated by the platform such as ROM 1404 and RAM 1406, although the system 1400 may receive programming and data via network communications. The system 1400 also may include input and output ports 1410 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

### NUMBERED EMBODIMENTS

Exemplary embodiments of the systems and methods disclosed herein are described in the numbered paragraphs below.

A1. A mass spectrometer, the mass spectrometer comprising:
a mass spectrometer filter assembly configured to provide one or more charged particles from a source;
a pusher-detection chamber configured to receive the one or more charged particles from the mass spectrometer filter assembly, wherein the pusher-detection chamber includes:
   a pusher assembly disposed in the pusher-detection chamber at a first location, and
   a detector disposed in the pusher-detection chamber at a second location; and
a time-of-flight (TOF) system configured to launch the one or more charged particles from the first location to the detector at the second location along a path using the pusher assembly, and determine a TOF for each of the one or more charged particles,
wherein the time-of-flight system includes:
   a high voltage pulse generator configured to output a high voltage pulse to cause the pusher assembly to launch the one or more charged particles;
   a pulse detector configured to detect the high voltage pulse and output a start signal;
   a time domain calculator configured to determine the TOF for each of the one or more charged particles based on a stopwatch;
   a start latch connected to the pulse detector and configured to start the stopwatch of the time domain calculator in response to receiving the start signal;
   a detection comparator connected to the detector and configured to output stop signals when a signal from the detector is greater than a first threshold;
   a stop latch connected to the detection comparator and configured to indicate stops to the stopwatch of the time domain calculator in response to receiving the stop signals; and
   a control system configured to control the high voltage pulse generator, the start latch, and the stop latch, and receive the determined TOF for each of the one or more charged particles from the time domain calculator.

A2. The mass spectrometer of A1, wherein the pulse detector is a detection circuit configured to detect the high voltage pulse and output the start signal.

A3. The mass spectrometer of A2, wherein the detection circuit is designed to have a response time under 2000 nanoseconds.

A4. The mass spectrometer of A2, wherein the detection circuit is designed to have a time jitter less than 100 picoseconds.

A5. The mass spectrometer of A2, wherein the detection circuit has a time jitter of less than 10% of a time jitter of the high voltage pulse generator.

A6. The mass spectrometer of A2, wherein the detection circuit includes a capacitive sensing component, and the capacitive sensing component is capacitively coupled to an electrical pathway that transmits the high voltage pulse between the high voltage pulse generator and the pusher assembly.

A7. The mass spectrometer of A6, wherein the capacitive sensing component includes a capacitor and a trigger that outputs the start signal when the capacitor senses a change due to the high voltage pulse.

A8. The mass spectrometer of A2, wherein the detection circuit includes an inductive sensing component, and the inductive sensing component is inductively coupled to an electrical pathway that transmits the high voltage pulse between the high voltage pulse generator and the pusher assembly.

A9. The mass spectrometer of A8, wherein the inductive sensing component includes an inductive wiring and a trigger that outputs the start signal when the inductive wiring senses a change due to the high voltage pulse.

A10. The mass spectrometer of any of A1-A9, wherein a time jitter of the TOF system does not include a time jitter associated with the high voltage pulse generator.

A11. A time-of-flight (TOF) system, the TOF system comprising:
a high voltage pulse generator configured to output a high voltage pulse to cause a pusher assembly to launch one or more charged particles;
a pulse detector configured to detect the high voltage pulse and output a start signal;
a time domain calculator configured to determine TOF for each of the one or more charged particles based on a stopwatch;
a start latch connected to the pulse detector and configured to start the stopwatch of the time domain calculator in response to receiving the start signal;
a detection comparator connected to the detector and configured to output stop signals when a signal from a detector is greater than a first threshold;
a stop latch connected to the detection comparator and configured to indicate stops to the stopwatch of the time domain calculator in response to receiving the stop signals; and
a control system configured to control the high voltage pulse generator, the start latch, and the stop latch, and receive the determined TOF for each of the one or more charged particles from the time domain calculator.

A12. The TOF system of A11, wherein the pulse detector is a detection circuit configured to detect the high voltage pulse and output the start signal.

A13. The TOF system of A12, wherein the detection circuit is designed to have a response time under 500-2000 nanoseconds.

A14. The TOF system of A12, wherein the detection circuit is designed to have a time jitter less than 100 picoseconds.

A15. The TOF system of A12, wherein the detection circuit has a time jitter of less than 10% a time jitter of the high voltage pulse generator.

A16. The TOF system of A12, wherein the detection circuit includes a capacitive sensing component, and the capacitive sensing component is capacitively coupled to an electrical pathway that transmits the high voltage pulse between the high voltage pulse generator and the pusher assembly.

A17. The TOF system of A16, wherein the capacitive sensing component includes a capacitor and a trigger that outputs the start signal when the capacitor senses a change due to the high voltage pulse.

A18. The TOF system of A12, wherein the detection circuit includes an inductive sensing component, and the inductive sensing component is inductively coupled to an electrical pathway that transmits the high voltage pulse between the high voltage pulse generator and the pusher assembly.

A19. The TOF system of A18, wherein the inductive sensing component includes an inductive wiring and a trigger that outputs the start signal when the inductive wiring senses a change due to the high voltage pulse.

A20. The TOF system of any of A11-A19, wherein a time jitter of the TOF system does not include a time jitter associated with the high voltage pulse generator.

B1. A mass spectrometer, the mass spectrometer comprising:
a mass spectrometer filter assembly configured to provide one or more charged particles from a source;
a pusher-detection chamber configured to receive the one or more charged particles from the mass spectrometer filter assembly, wherein the pusher-detection chamber includes:
   a pusher assembly disposed in the pusher-detection chamber at a first location, and
   a detector disposed in the pusher-detection chamber at a second location; and
a time-of-flight (TOF) system configured to launch the one or more charged particles from the first location to the detector at the second location along a path using the pusher assembly, and determine a TOF for each of the one or more charged particles,
wherein the time-of-flight system includes:
   a high voltage pulse generator configured to output a high voltage pulse to cause the pusher assembly to launch the one or more charged particles;
   a time domain calculator configured to determine the TOF for each of the one or more charged particles based on a stopwatch;
   a detection comparator connected to the detector and configured to output a timer signal when a signal from the detector is greater than a threshold value;
   a start latch connected to the detection comparator and configured to indicate a start to the stopwatch of the time domain calculator in response to receiving the timer signal;
   a stop latch connected to the detection comparator and configured to indicate stops to the stopwatch of the time domain calculator in response to receiving the timer signals; and
   a control system configured to control the high voltage pulse generator, the start latch, and the stop latch, and receive the determined TOF for each of the one or more charged particles from the time domain calculator.

B2. The mass spectrometer of B1, wherein the detector is configured to (1) detect the one or more charged particles when the one or more charged particles strike the detector and (2) detect electric fields generated by the pusher assembly when the high voltage pulse is applied to the pusher assembly to launch the one or more charged particles.

B3. The mass spectrometer of any of B1-B2, wherein the control system is further configured to hold and release the start latch and the stop latch in accordance to a defined timing sequence.

B4. The mass spectrometer of B3, wherein the defined timing sequence includes releasing the start latch before the stop latch.

B5. The mass spectrometer of B3, wherein the defined timing sequence includes releasing the start latch before the high voltage pulse is applied to the pusher assembly.

B6. The mass spectrometer of B3, wherein the defined timing sequence includes releasing the stop latch after the high voltage pulse is applied to the pusher assembly.

B7. The mass spectrometer of any of B1-B6, wherein the time-of-flight system further includes a threshold switch connected as an input to the detection comparator, and the threshold switch is configured to switch between a push threshold and an ion threshold.

B8. The mass spectrometer of B7, wherein the control system is further configured to cause the threshold switch to switch between the push threshold and the ion threshold in accordance to a defined timing sequence.

B9. The mass spectrometer of B8, wherein the defined timing sequence includes switching the threshold switch to the push threshold before the high voltage pulse is applied to the pusher assembly.

B10. The mass spectrometer of B8, wherein the defined timing sequence includes switching the threshold switch to the ion threshold before releasing the stop latch.

B11. The mass spectrometer of B7, wherein the push threshold and the ion threshold are the same, or the push threshold is greater than the ion threshold by at least 100%.

B12. A time-of-flight (TOF) system, the TOF system comprising:
a high voltage pulse generator configured to output a high voltage pulse to cause a pusher assembly to launch one or more charged particles;
a time domain calculator configured to determine TOF for each of the one or more charged particles based on a stopwatch;
a detection comparator connected to a detector and configured to output a timer signal when a signal from the detector is greater than a threshold value;
a start latch connected to the detection comparator and configured to indicate a start to the stopwatch of the time domain calculator in response to receiving the timer signal;
a stop latch connected to the detection comparator and configured to indicate stops to the stopwatch of the time domain calculator in response to receiving the timer signals; and
a control system configured to control the high voltage pulse generator, the start latch, and the stop latch, and receive the determined TOF for each of the one or more charged particles from the time domain calculator.

B13. The TOF system of B12, wherein the detector is configured to (1) detect the one or more charged particles when the one or more charged particles strike the detector and (2) detect electric fields generated by the pusher assembly when the high voltage pulse is applied to the pusher assembly to launch the one or more charged particles.

B14. The TOF system of any of B12-B13, wherein the control system is further configured to hold and release the start latch and the stop latch in accordance to a defined timing sequence.

B15. The TOF system of B14, wherein the defined timing sequence includes releasing the start latch before the stop latch.

B16. The TOF system of B14, wherein the defined timing sequence includes releasing the start latch before the high voltage pulse is applied to the pusher assembly.

B17. The TOF system of B14, wherein the defined timing sequence includes releasing the stop latch after the high voltage pulse is applied to the pusher assembly.

B18. The TOF system of any of B12-B17, wherein the time-of-flight system further includes a threshold switch connected as an input to the detection comparator, and the threshold switch is configured to switch between a push threshold and an ion threshold.

B19. The TOF system of B18, wherein the control system is further configured to cause the threshold switch to switch between the push threshold and the ion threshold in accordance to a defined timing sequence.

B20. The TOF system of B19, wherein the defined timing sequence includes switching the threshold switch to the push threshold before the high voltage pulse is applied to the pusher assembly.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations are not intended to convey that the claimed subject matter requires features or combinations of features other than those expressly recited in the claims. Accordingly, the scope of this disclosure is intended to include all modifications and variations encompassed within the spirit and scope of the following appended claims.

What is claimed:

1. A mass spectrometer, the mass spectrometer comprising:
a mass spectrometer filter assembly configured to provide one or more charged particles from a source;
a pusher-detection chamber configured to receive the one or more charged particles from the mass spectrometer filter assembly, wherein the pusher-detection chamber includes:
a pusher assembly disposed in the pusher-detection chamber at a first location, and
a detector disposed in the pusher-detection chamber at a second location; and
a time-of-flight (TOF) system configured to launch the one or more charged particles from the first location to the detector at the second location along a path using the pusher assembly, and determine a TOF for each of the one or more charged particles,
wherein the time-of-flight system includes:
a high voltage pulse generator configured to output a high voltage pulse to cause the pusher assembly to launch the one or more charged particles;
a time domain calculator configured to determine the TOF for each of the one or more charged particles based on a stopwatch;
a detection comparator connected to the detector and configured to output a timer signal when a signal from the detector is greater than a threshold value;
a start latch connected to the detection comparator and configured to indicate a start to the stopwatch of the time domain calculator in response to receiving the timer signal;
a stop latch connected to the detection comparator and configured to indicate stops to the stopwatch of the time domain calculator in response to receiving the timer signals; and
a control system configured to control the high voltage pulse generator, the start latch, and the stop latch, and receive the determined TOF for each of the one or more charged particles from the time domain calculator.

2. The mass spectrometer of claim 1, wherein the detector is configured to (1) detect the one or more charged particles when the one or more charged particles strike the detector and (2) detect electric fields generated by the pusher assembly when the high voltage pulse is applied to the pusher assembly to launch the one or more charged particles.

3. The mass spectrometer of claim 1, wherein the control system is further configured to hold and release the start latch and the stop latch in accordance to a defined timing sequence.

4. The mass spectrometer of claim 3, wherein the defined timing sequence includes releasing the start latch before the stop latch.

5. The mass spectrometer of claim 3, wherein the defined timing sequence includes releasing the start latch before the high voltage pulse is applied to the pusher assembly.

6. The mass spectrometer of claim 3, wherein the defined timing sequence includes releasing the stop latch after the high voltage pulse is applied to the pusher assembly.

7. The mass spectrometer of claim 1, wherein the time-of-flight system further includes a threshold switch connected as an input to the detection comparator, and the threshold switch is configured to switch between a push threshold and an ion threshold.

8. The mass spectrometer of claim 7, wherein the control system is further configured to cause the threshold switch to switch between the push threshold and the ion threshold in accordance to a defined timing sequence.

9. The mass spectrometer of claim 8, wherein the defined timing sequence includes switching the threshold switch to the push threshold before the high voltage pulse is applied to the pusher assembly.

10. The mass spectrometer of claim 8, wherein the defined timing sequence includes switching the threshold switch to the ion threshold before releasing the stop latch.

11. The mass spectrometer of claim 7, wherein the push threshold and the ion threshold are the same, or the push threshold is greater than the ion threshold by at least 100%.

12. A time-of-flight (TOF) system, the TOF system comprising:
a high voltage pulse generator configured to output a high voltage pulse to cause a pusher assembly to launch one or more charged particles;
a time domain calculator configured to determine TOF for each of the one or more charged particles based on a stopwatch;
a detection comparator connected to a detector and configured to output a timer signal when a signal from the detector is greater than a threshold value;
a start latch connected to the detection comparator and configured to indicate a start to the stopwatch of the time domain calculator in response to receiving the timer signal;
a stop latch connected to the detection comparator and configured to indicate stops to the stopwatch of the time domain calculator in response to receiving the timer signals; and
a control system configured to control the high voltage pulse generator, the start latch, and the stop latch, and receive the determined TOF for each of the one or more charged particles from the time domain calculator.

13. The TOF system of claim 12, wherein the detector is configured to (1) detect the one or more charged particles when the one or more charged particles strike the detector and (2) detect electric fields generated by the pusher assembly when the high voltage pulse is applied to the pusher assembly to launch the one or more charged particles.

14. The TOF system of claim 12, wherein the control system is further configured to hold and release the start latch and the stop latch in accordance to a defined timing sequence.

15. The TOF system of claim 14, wherein the defined timing sequence includes releasing the start latch before the stop latch.

16. The TOF system of claim 14, wherein the defined timing sequence includes releasing the start latch before the high voltage pulse is applied to the pusher assembly.

17. The TOF system of claim 14, wherein the defined timing sequence includes releasing the stop latch after the high voltage pulse is applied to the pusher assembly.

18. The TOF system of claim 12, wherein the time-of-flight system further includes a threshold switch connected as an input to the detection comparator, and the threshold switch is configured to switch between a push threshold and an ion threshold.

19. The TOF system of claim 18, wherein the control system is further configured to cause the threshold switch to switch between the push threshold and the ion threshold in accordance to a defined timing sequence.

20. The TOF system of claim 19, wherein the defined timing sequence includes switching the threshold switch to the push threshold before the high voltage pulse is applied to the pusher assembly.
